(19) United States
(12) Patent Application Publication
(10) Pub. No.: US 2018/0089689 A1
(43) Pub. Date: Mar. 29, 2018

(54) DEDICATED PAYMENT TERMINAL FOR MITIGATING INSTANCES OF CARD HOLDER FRAUD USING IMAGE CAPTURE AND METHOD

(71) Applicant: Trevor Shaw, Lehi, UT (US)

(72) Inventor: Trevor Shaw, Lehi, UT (US)

(21) Appl. No.: 15/277,668

(22) Filed: Sep. 27, 2016

(51) Int. Cl. G06Q 20/40; G06K 7/08; G06K 7/00; G06Q 20/20; G06Q 20/02

(52) U.S. Cl. CPC G06Q 20/40145; G06K 7/087; G06Q 20/409; G06Q 20/204; G06Q 20/027; G06K 7/0004

(57) ABSTRACT

A credit card terminal is provided for mitigating consumer credit card fraud comprising a card reader and image capture means. The terminal comprises a camera activated during transaction processing which records in computer-readable memory media of the purchaser. This media may thereafter be referenced to verify the identity of the purchaser upon purchaser chargeback.

### BACKGROUND OF THE INVENTION

### Field of the Invention

This invention relates generally to credit car terminals, and more specifically relates to credit card terminals transmitting computer-readable information for storage over a signal-bearing medium.

### Description of the Related Art

Dedicated credit card terminals are well-known in the art. These terminals are commonly used when a consumer makes a purchase using a credit card from a merchant. At present, such cards bear a stripe or track of magnetic media that encodes the card owner's account information, though newer cards are being introduced to the market with integrated chips which store card holder account number, account limits and other data on an internal solid state memory that can be read or written to electronically by more modern point of sale transaction devices.

There is a limit to the information storable on existing cards, but increasing storage capacity of cards does not alleviate fraud-related liabilities. The prevention of theft and fraud by non-authorized users of credit cards, or by authorized users pretending to later have been unauthorized users (“friendly fraud”), has always been a concern in the art which has never been solved efficiently. Two means of ensuring a user of credit card is authorized have been widely implemented: (1) requiring a signature of the purchaser; and (2) requiring a PIN number.

In promotion of security, the consumer is prompted in the case of debit cards to input some sort of personal identification number (“PIN”) to confirm that the consumer is indeed the authorized card owner. Entry is commonly made with a real or virtual (e.g., displayed) keypad, or more commonly pinpad, associated with the system in question. PIN information is typically not encoded on the magnetic stripe of a credit type card itself or chip.

At present, PIN numbers are required for debit cards but are not required for credit cards. Merchant processors, and clearinghouse system providing credit card authorizations, purport to check the signature made at the time of purchase against a signature of the authorized card holder to verify identity. In practice, this system is useless. Even in response to chargeback requests, signature verification is usually not performed, and when it is, it can be impossible to confirm similarity of signatures. The inefficiencies in the art this methodology has created have encouraged fraud by allowing an authorized purchaser to simply chargeback, or reverse a transaction, by claiming he or she was not the individual who actually made the purchase.

Liability for chargebacks is placed by merchant processors of the merchants running the credit card terminals, who are the primary victims of fraud of theft in these transactions. Current network structure and methodology often pose risks for merchants, who are forced to bear the liability for fraudulent purchases. Signature verification has been shown to have little value in actually identifying the individuals initiating a purchase and represents an anachronism in the art from a bygone era when cameras, digital bandwidth, and computer storage were not sufficient to facilitate implementation of more advanced methods of verifying purchaser identity. A more efficient means of verifying purchaser identity is desirable in the art.

### SUMMARY OF THE INVENTION

From the foregoing discussion, it should be apparent that a need exists for a computer program product, apparatus, method and system for mitigating instances of card holder fraud. Beneficially, such a system would capture, compress and store media of a purchaser making a purchase in computer-readable memory.

The present invention has been developed in response to the problems and needs in the art that have not yet been fully solved by currently available apparati and methods. Accordingly, the present invention has been developed to provide a credit card terminal with image capture means, the credit card terminal comprising: a body for receiving, storing and transmitting information having a top portion, and a forward portion; computer-readable memory; key means disposed in said top portion; a first display means disposed in said top portion for displaying information for displaying information to a purchaser; magnetic reader means operatively affixed to the body for reading a magnetic stripe on a credit card; and a camera for recording media of a purchasers making use of the credit card terminal, the camera configured to record the media while the magnetic reader is in use.

The card reader may consist of one of a magnetic card reader, a chip reader, an NFC reader, and an RFID reader. The credit card terminal may further comprising a second display means adapted to display media received from an acquiring bank comprising prerecorded media of an authorized user of the credit card.

The prerecorded media may be captured by an acquiring bank in person when a purchaser is authorized to use the credit card. The credit card terminal may further comprise computer-readable instructions in the computer-readable memory operable to perform facial recognition analysis on the media and the prerecorded media, and confirm the purchaser's identity.

A method for reducing credit card fraud by consumers using image capture is also provided, the steps of the method comprising: receiving account information from a magnetic stripe on a credit card using a magnetic scanner; capturing media of a purchaser using a camera oriented to face the purchaser; storing the media in computer-readable memory exclusively associated with a purchase; creating a purchase authorization request comprising the account information, the media, a date, and a purchase amount; relaying the purchase authorization request to an acquiring bank via a WAN; and receiving purchase authorization confirmation from the acquiring bank.

The media may comprise an image. The media may comprise video.

The method may further comprise caching a plurality of purchase authorization requests for transmittal in a batch to a gateway processor.

The method may further comprise: receiving media from the acquiring bank comprising media of an authorized user of the credit card; displaying the media on GUI for merchant review and approval; and sending confirmation of merchant approval of the media to the acquiring bank.

The method may further comprise executing computer-readable instructions forming facial recognition software to confirm the identity of the purchaser.

The method may further comprise: performing facial recognition analysis on the media and the prerecorded media to create a match correlation parameter; and authorizing payment in response to the match correlation parameter exceeding a predetermined threshold.

A method for reducing credit card fraud by consumers using image capture on a smartphone is also provided, the steps of the method comprising: receiving account information from a magnetic stripe on a credit card using a portable magnetic scanner in logical connectivity with a smartphone; automatically capturing media of a purchaser using a camera on the smartphone oriented to face the purchaser while the purchaser is using the portable magnetic scanner; storing the media in computer-readable memory exclusively associated with a purchase; creating a purchase authorization request comprising the account information, the media, a date, and a purchase amount; relaying the purchase authorization request to an acquiring bank via a WAN; and receiving purchase authorization confirmation from the acquiring bank.

The method may further comprise storing the media in computer-readable memory exclusively associated with the purchaser.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is forward perspective view of a credit card terminal in accordance with an embodiment of the present invention;

FIG. 2A is forward perspective view of a credit card terminal in accordance with an embodiment of the present invention;

FIG. 2B is forward perspective view of a credit card terminal and attached GUI in accordance with an embodiment of the present invention;

FIG. 2C is forward perspective view of a credit card terminal and attached GUI in accordance with an embodiment of the present invention;

FIG. 3 is an entity-relationship diagram illustrating data flow between entities in accordance with the present invention;

FIG. 4 is flow chart of a method used by the system for mitigating credit card fraud using image capture;

FIG. 5 is a block diagram illustrating modules of a system in accordance with the present invention; and

FIG. 6 is a block diagram illustrating modules of a system and data flow in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a system, apparatus, computer program product, and a method for mitigating instances of card holder fraud using image capture. Those individuals and entities purchasing a consumer good, service or any other product at a credit card terminal are referred to herein as consumers, shoppers or requestors and these terms are used synonymously throughout this specification. Similarly individuals or organizations who are willing to provide the desired goods and services are herein referred to as merchants, while organizations authorizing purchases are referred hereinafter as merchant processors or clearinghouse system. Additionally, the community described herein may be referred to as a network as used throughout this specification. Consumers and merchants may also be referred to collectively hereinafter as users.

Hence, in general terms, the present invention provides for a POS with an integrated camera for capturing photographs and/or media of a purchaser. This media is stored in computer-readable memory within a RDBMS (relational database management system) under the control of merchant and/or a merchant processor.

The system, CPP and method allow a merchant and/or a merchant processor to verify the identity visually of a purchaser if a purchase is in dispute after a chargeback request.

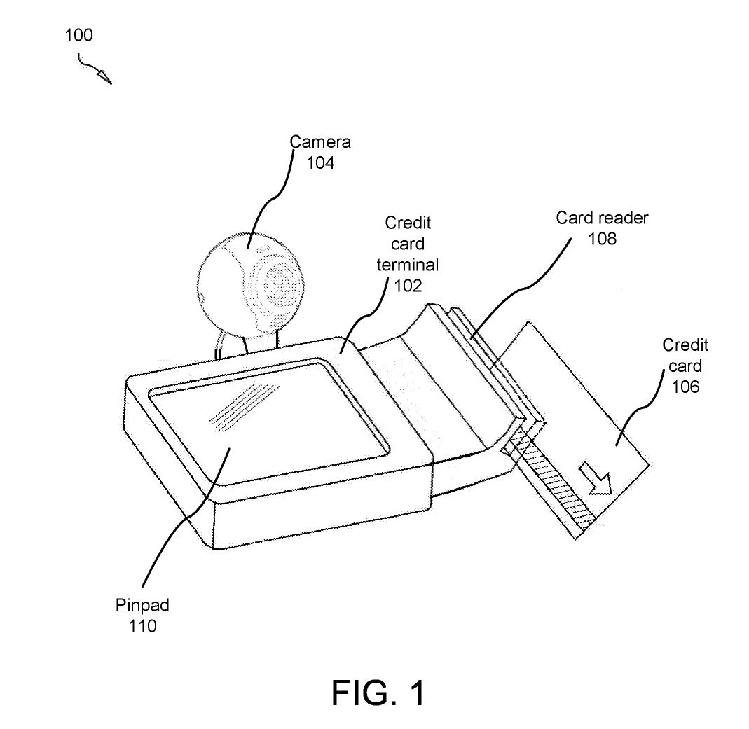

Accordingly, FIG. 1 is forward perspective view of a credit card terminal in accordance with an embodiment of the present invention. Electronics within the terminal 100 operate in conjunction with software to captures media in real time of an individual making a purchase at the terminal 100 and compress the media. The compressed media may then be transmitted by to a remote host system under the control of a merchant processor, which stores a valid exemplar of the media in computer-readable memory.

The terminal 100 is provided with a card reader 108. In the shown embodiments, the card reader 108 comprises a magnetic card stripe reader. The card reader 108, in other embodiments, may comprise a smart payment card reader for reading the chips on EMV cards (or “chip cards” or “IC cards”). The card reader may also comprise an NFC reader, Bluetooth® or RFID reader, or other contactless reader as known to those of skill in the art.

The terminal 100 comprises a pinpad 110 which may comprise or consist of a touch screen GUI. A user may manually enter a PIN by touching various of the keys displayed on pinpad 110, or using a stylus or other object. The terminal 100 may comprise an application-specific integrated circuit (“ASIC”).

A camera 104 is shown, adapted to record digital media of a purchaser making use of the terminal 100. In various embodiments, the camera 104 records video, photograph, audio, or some combinations of all of the above. The media may be stored, relayed and remitted in MPEG, JPG, MP3, MP4 or other formats known to those of skill in the art.

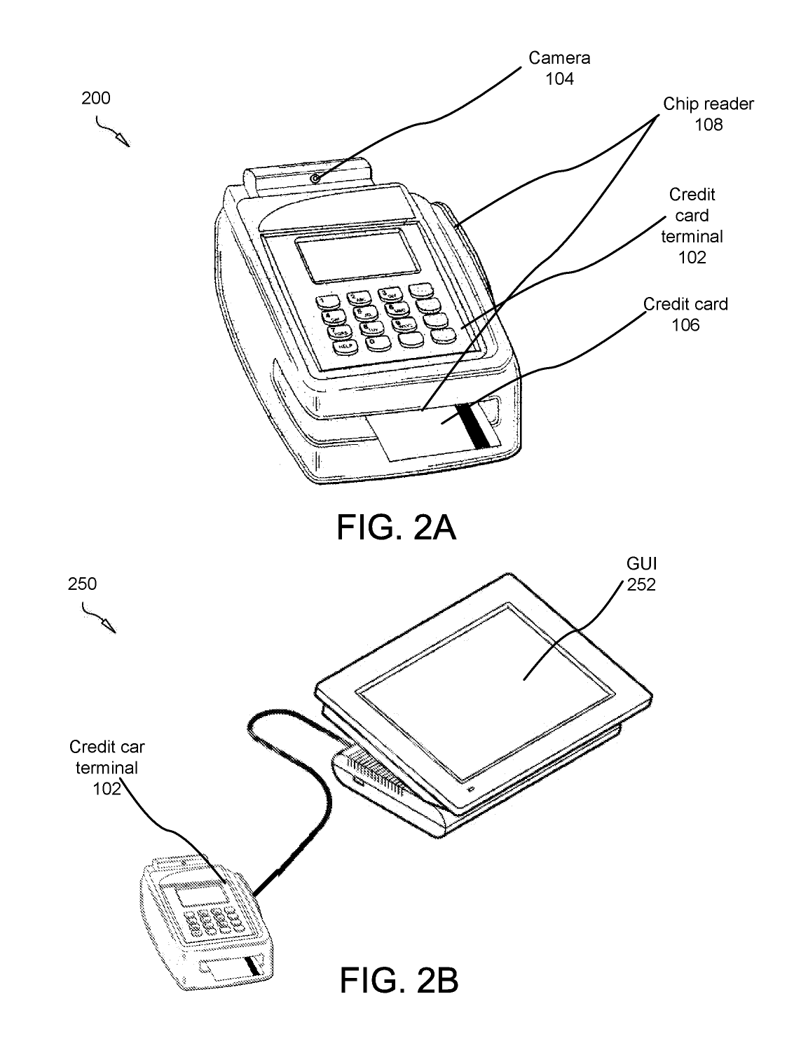

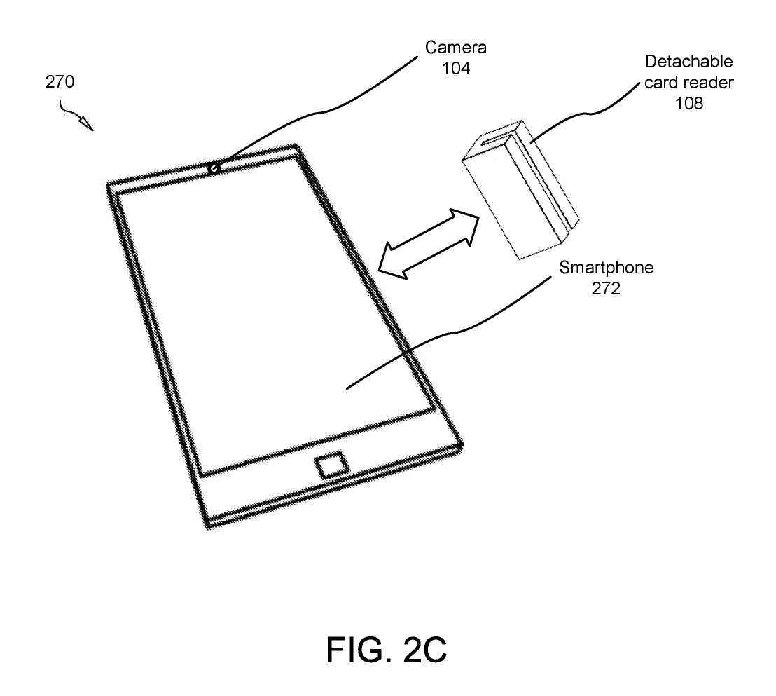

FIG. 2A is forward perspective view of a credit card terminal 200 in accordance with an embodiment of the present invention.

The credit card terminal 200 comprises an integrated camera for recording media of a purchaser while the purchaser is using the magnetic card stripe reader 108. In various embodiments, the terminal 200 is adapted to, or configured to, activate the camera 104 in response to a credit card being swiped, or read, by the magnetic card stripe reader 108. In other embodiments, the camera is activated 104 when a merchant has successfully scanned a bar code on a consumer product.

FIG. 2B is forward perspective view of a credit card terminal and attached GUI 250 in accordance with an embodiment of the present invention.

In the shown embodiments, a GUI 252 is in logical connectivity with the terminal 102. The terminal 102 is in logical connectivity with an acquiring bank or merchant processor.

In various embodiments, the terminal 250 comprises a GUI 252 for viewing media transmitted from a merchant processor or clearinghouse system. In various embodiments of the present invention, media comprising an image or video of a purchaser is recorded in computer-readable memory before a credit account is authorized or opened for the purchaser. An agent of the merchant processor ensures the image or video accurately depicts the account holder or purchaser.

This terminal 250 may comprise a transmitter and receiver with the logic necessary to receive and transmit bitstreams (i.e. data streams). The terminal 250 modules may include the software, firmware, and hardware necessary to receive and process video content and media between merchants and merchant processors, including buffers, data unloaders, video unloaders, and the like. The terminal 250 may also include a multiplexor functionally capable of demultiplexing packets for purpose of performing automated facial recognition analysis for the purpose of confirming purchaser identity.

The terminal 250 may conform to the UnifiedPOS standard, OPOS, and/or JavaPOS. The credit card 106 and terminal 250 may conform to the standards of the Payment Card Industry Security Standards Council (PCI SSC).

FIG. 2C is forward perspective view of a credit card terminal and attached GUI 270 in accordance with an embodiment of the present invention.

The credit card terminal 270 comprises a smartphone 272 in logical connectivity to a card reader 108, which is shown as a detachable magnetic card stripe reader. In other embodiments, the card reader 108 comprises an NFC reader, Bluetooth® or RFID reader as known to those of skill in the art.

Examples of these readers include an iCMP Bluetooth credit card reader, a MagTek® Dynamag, and the like.

The smartphone 272 may be configured to use an integrated camera 104 to capture media of a purchaser making use of the magnetic card stripe reader 108.

The smartphone 272 may comprise any number of commercially available computer applications for processing credit card transactions. The smartphone 272 may be configured by these applications, or other computer-readable instructions, to begin recording media when a merchant instructs, when a transaction is ready for processing and relay to an acquiring bank, or when the detachable magnetic card stripe reader 108 is engaged by the credit card of the purchaser.

The smartphone 272 may comprise, internally or externally, an Interactive Voice Response (IVR), which recognizes natural voice communication or DTMF keypad input.

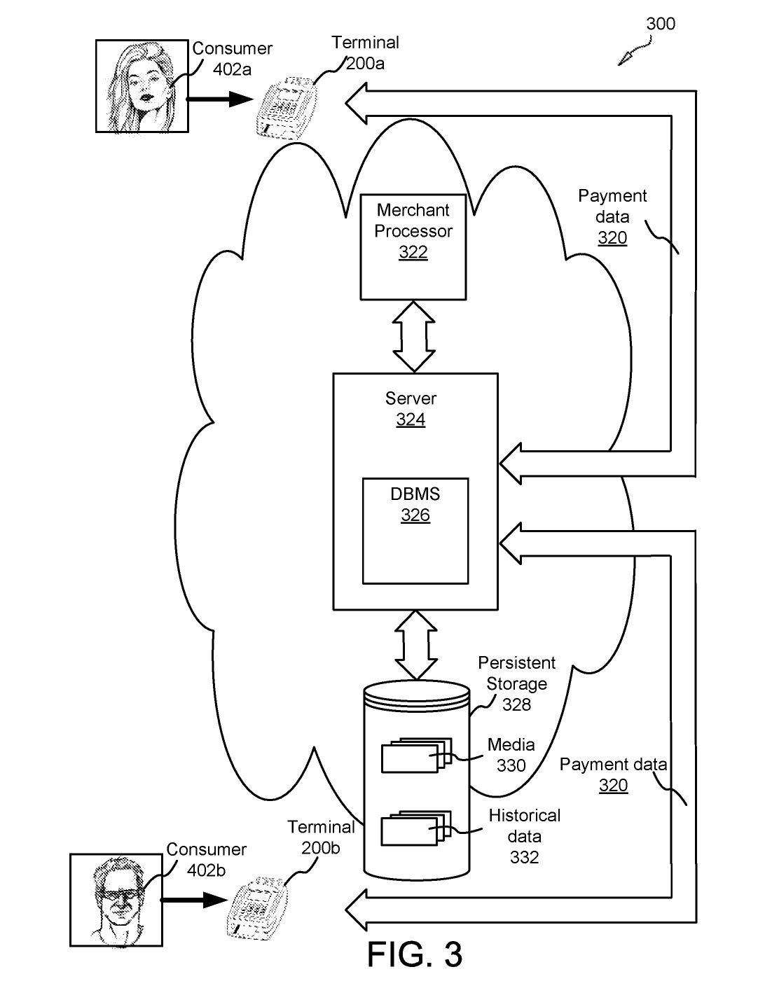

FIG. 3 is an entity-relationship diagram illustrating data flow 300 between entities in accordance with the present invention.

In image 402 is captured of each consumer making a purchase using a terminal 200. The purchase request comprising the media is packaged as payment data 320 and relayed to a merchant processor 322 or acquiring bank via a server 324 in logical connectivity with the terminals 200a-b.

The images 402 of each consumer are recorded in computer-readable persistent storage 328. In some embodiments, the images 402 are recorded in DBMS collectively 330 along with historical data associated with a purchaser, merchant and date.

The server 324 may comprise a database management system (DBMS) 326, persistent storage 328, stored media 330, stored historical data 332. Typically, the server 324 comprises one or more central processing units executing software and/or firmware to control and manage the other components within the system 300. In one embodiment, the server 324 comprises hardware and/or software more commonly referred to as a Multiple Virtual Storage (MVS), OS/390, zSeries/Operating System (z/OS), UNIX, Linux, or Windows.

The server 324 may comprise a server cluster with firewalls, load balancer, and database servers having Apache® and/or other software applications well-known to those of skill in the art. The DBMS 326 or relational database management system (RDBMS), may be one of Oracle, MySQL, SQL, FireBird, IBM DB2®, or the like.

The server 324 is in logical communication with one or more merchants through a networked environment, such as local area network (LAN) or wide area network (WAN). The server 324 may communicate with merchants, acquiring banks, merchants processors, and the like.

The media may be relayed to and from merchant processors using variations of the Simple Mail Transfer Protocol (SMTP), Internet Message Access Protocol (IMAP), Post Office Protocol (POP), or other protocols well-known to those of skill in the art.

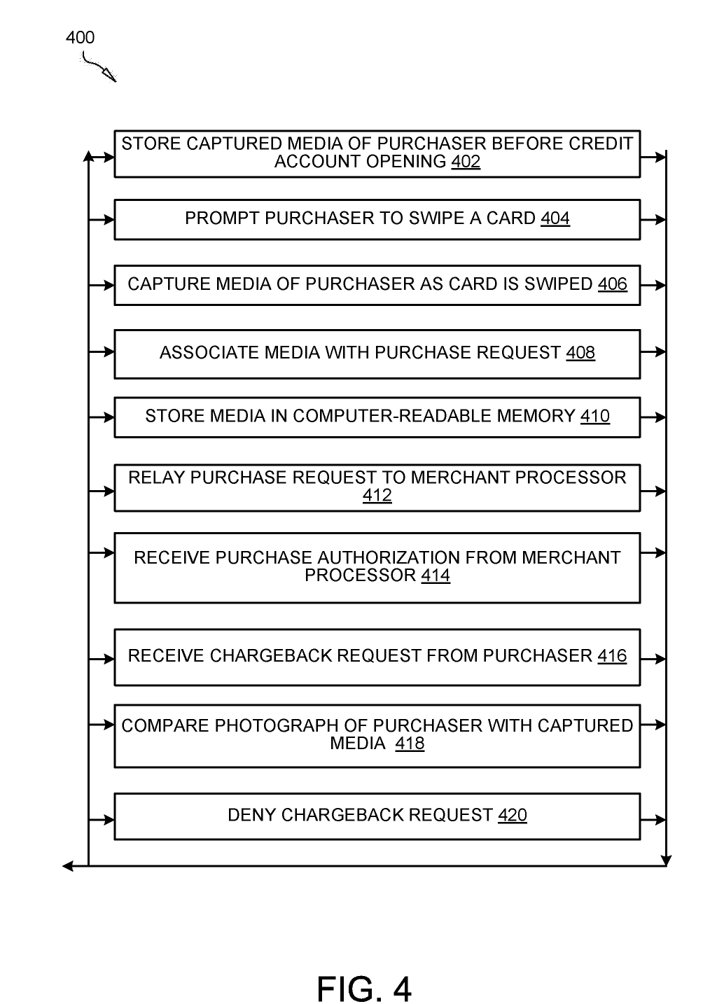

FIG. 4 is flow chart of a method 400 in accordance with the present invention.

An acquiring bank or other technology provider stores 402 captured media of a credit account holder when the credit account is opened in memory. In other embodiments, step 402 is omitted.

A purchaser at a merchant location is prompted 404 to swipe a credit card through a magnetic card reader 108. At this point, additional media is captured 406 by a camera integrated into a terminal. The camera may be adapted to record media upon instruction of the merchant or activation of the magnetic card reader 108.

The media of the purchaser is captured, stored 410 in memory, and associated 408 with the data relayed 412 to the acquiring bank (the “purchase request”), after which acquiring bank or merchant processor relays back a confirmation to the merchant.

In some embodiments, the acquiring bank may send back media of the authorized account holder to the merchant for comparison and identity verification.

In some embodiments of the present invention, prerecorded media comprising an image or video of the account holder is relayed to the merchant and stored in persistent or non-persistent computer-readable memory on a DPD under the control of the merchant. This prerecorded media is compared using facial recognition software, as known to those of skill in the art, to media taken of the purchaser on site at the merchant place of business. A Boolean may be evaluated as true if the prerecorded media matches the media, the Boolean stored in persistent memory, and relayed to a merchant processor or acquiring bank.

In some embodiments, the facial recognition software is used not to create a Boolean evaluating as true in the case of match, but a match correlation parameter which may comprise a variable or datatype in computer readable memory. The match correlation parameter may increase with increasing match correlation criteria being satisfied by the facial recognition software. Using this methodology, a merchant may be permitted to set a predetermined threshold above which a purchases exclusively associated with a match correlation parameter is approved. In so doing, a merchant may selectively assign an acceptable risk level to purchases made at the merchant location.

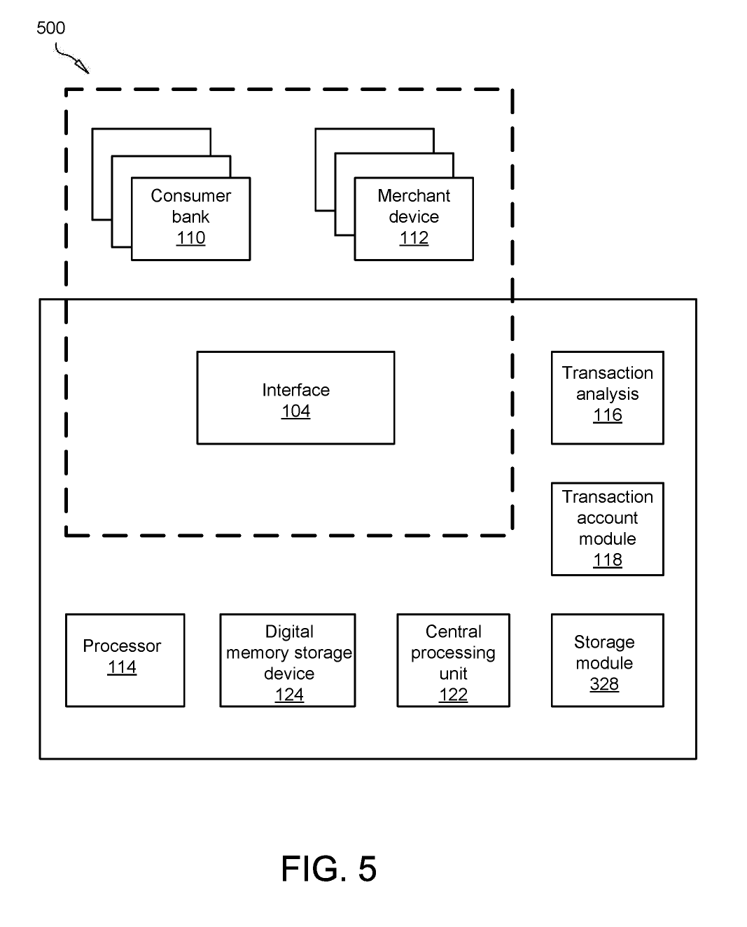

FIG. 5 is a block diagram illustrating modules of a system in accordance with the present invention.

The system 500 is shown and described broadly in FIG. 5, and with more specificity with respect to previous or subsequent figures. The system 500 can receive real time data from merchant processor for a given purchase request and can analyze the real time data along with previously stored data to match transactions between purchasers and merchant processors.

The system 100 can include an interface, indicated generally at 104, for interacting with a merchant device and/or consumer bank, indicated generally at 110 and 112, respectively. In one aspect the interface 104 can include a network, indicated generally, that can be established between the merchant device 112 and consumer bank 110.

The system 500 can also include a processor, indicated generally at 114, that can receive, process, analyze, manipulate, store and transmit data between the consumer bank 110 and merchant processor 112. For example, the processor 114 can include a transaction analysis module, indicated generally at 116, that can receive and request media associated with a consumer purchase.

In this way, the system 400 may include one or more processors 114 that execute instructions on a computer-readable medium, such as a central processing unit, indicated generally at 122, or digital memory storage device 328, that cause the one or more processors 114 to make a media match determination.

In one aspect, the system 100 can also include a plurality of mobile computing devices under the control of merchants.

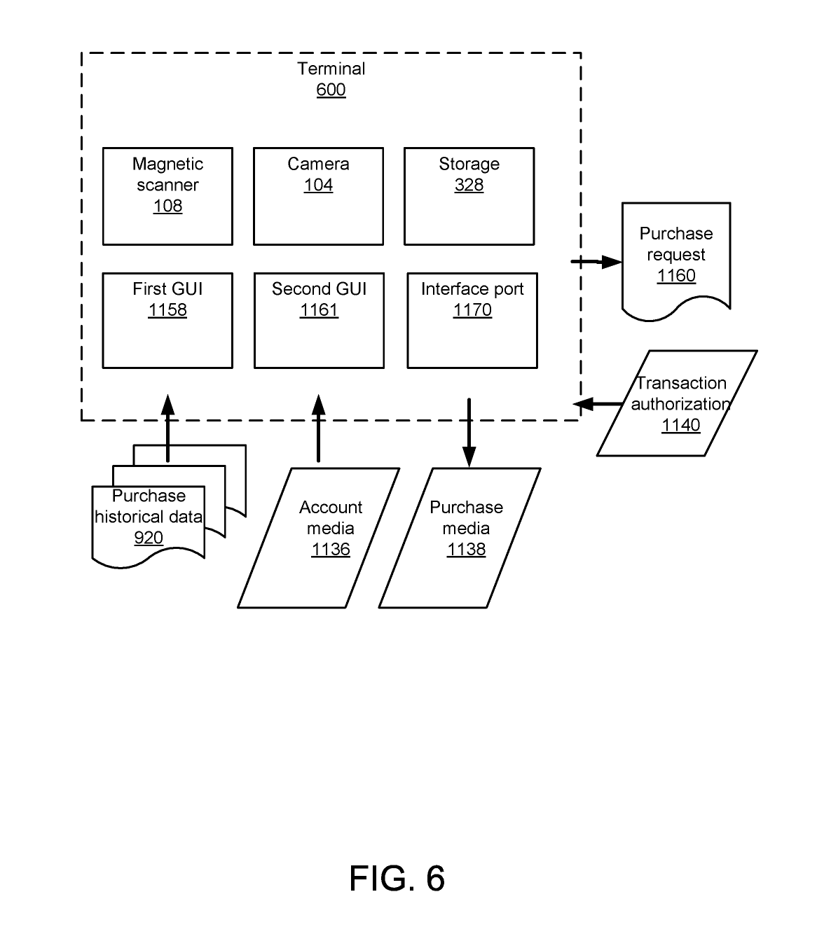

FIG. 6 is a block diagram illustrating modules of a system 600 and data flow in accordance with the present invention.

Multiple item requests exclusively associated with said provider may be organized within a larger scheduling file and/or may be sorted and stored in the RDBMS 326.

The terminal 600 may comprises a magnetic scanner 108, a camera 104, storage 328, a first GUI, a second GUI, and an interface port 1170.

In the shown the embodiment, media 402 is uploaded via a WAN to the acquiring bank in the form of a purchase media 1133 file. In some embodiments, the media 1136 recorded at the time an account is opened is relayed to the system 600. This media may be relayed in conjunction with transaction 1140. The purchase media 1138 may be transmitted or uploaded to the acquiring bank in conjunction with a purchase request 1160.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A credit card terminal with image capture means, the credit card terminal comprising:
a body for receiving, storing and transmitting information having a top portion, and a forward portion;
computer-readable memory;
key means disposed in said top portion;
a first display means disposed in said top portion for displaying information for displaying information to a purchaser;
a card reader means operatively affixed to the body for reading account information on a credit card; and
a camera for recording media of a purchasers making use of the credit card terminal, the camera configured to record the media while the magnetic reader is in use.

2. The credit card terminal of claim 1, wherein the card reader consists of one of a magnetic card stripe reader, a EMV chip reader, an NFC reader, and an RFID reader.

3. The credit card terminal of claim 1, further comprising a second display means adapted to display media received from an acquiring bank comprising prerecorded media of an authorized user of the credit card.

4. The credit card terminal of claim 1, wherein in the prerecorded media is captured by an acquiring bank in person when a purchaser is authorized to use the credit card.

5. A method for reducing credit card fraud by consumers using image capture, the steps of the method comprising:
receiving account information from a credit card using a card reader;
capturing media of a purchaser using a camera oriented to face the purchaser;
storing the media in computer-readable memory exclusively associated with a purchase;
creating a purchase authorization request comprising the account information, the media, a date, and a purchase amount;
relaying the purchase authorization request to an acquiring bank via a WAN; and
receiving purchase authorization confirmation from the acquiring bank.

6. The method of claim 5, wherein the media comprises an image.

7. The method of claim 5, wherein the media comprises video.

8. The method of claim 5, further comprising caching a plurality of purchase authorization requests for transmittal in a batch to a gateway processor.

9. The method of claim 5, wherein the card reader consists of one of a magnetic card stripe reader, a EMV chip reader, an NFC reader, and an RFID reader.

10. The method of claim 5, further comprising:
receiving media from the acquiring bank comprising media of an authorized user of the credit card;
displaying the media on GUI for merchant review and approval; and
sending confirmation of merchant approval of the media to the acquiring bank.

11. The method of claim 10, further comprising executing computer-readable instructions forming facial recognition software to confirm the identity of the purchaser.

12. The method of claim 11, further comprising:
performing facial recognition analysis on the media and the prerecorded media to create a match correlation parameter; and
authorizing payment in response to the match correlation parameter exceeding a predetermined threshold.

13. A method for reducing credit card fraud by consumers using image capture on a smartphone, the steps of the method comprising:
receiving account information from a magnetic stripe on a credit card using a portable card reader in logical connectivity with a smartphone;
automatically capturing media of a purchaser using a camera on the smartphone oriented to face the purchaser while the purchaser is using the portable magnetic scanner;
storing the media in computer-readable memory exclusively associated with a purchase;
creating a purchase authorization request comprising the account information, the media, a date, and a purchase amount;
relaying the purchase authorization request to an acquiring bank via a WAN; and
receiving purchase authorization confirmation from the acquiring bank.

14. The method of claim 13, further comprising storing the media in computer-readable memory exclusively associated with the purchaser.

15. The method of claim 13, wherein the card reader consists of one of a magnetic card stripe reader, an EMV chip reader, an NFC reader, and an RFID reader.
